(19) United States
(12) Patent Application Publication
(10) Pub. No.: US 2026/0034663 A1
(43) Pub. Date: Feb. 5, 2026

(54) Picking Device

(71) Applicant: Wendy English, Middletown, NY (US)

(72) Inventor: Wendy English, Middletown, NY (US)

(21) Appl. No.: 19/285,553

(22) Filed: Jul. 30, 2025

Related U.S. Application Data
(60) Provisional application No. 63/676,984, filed on Jul. 30, 2024.
(60) Provisional application No. 63/707,978, filed on Oct. 16, 2024.

(51) Int. Cl. B25J 1/02; B25J 15/00; B25J 15/06; B25J 18/02

(52) U.S. Cl. CPC B25J 1/02; B25J 18/025; B25J 15/0019; B25J 15/008; B25J 15/0608

(57) ABSTRACT

A picking device is provided comprised of a body that may include a hinge for folding, facilitated by a locking button or similar control, or may be telescopic, allowing extension or retraction to specified lengths secured by a locking member, preventing unintended adjustments. One end of the device features a handle, ergonomically designed and equipped with a grip area, hanging opening, and an optional adjustable wrist loop for enhanced usability and security. The opposite end includes a head, which may be fixed or articulated through a pivot point, allowing for versatile interaction angles. The head incorporates a fastener, such as an adhesive, magnetic, or hook element, to engage with objects, and may offer replaceable fasteners for task-specific applications, thereby enhancing the device's adaptability.

### CROSS-REFERENCE TO RELATED APPLICATION

The present application claims priority to, and the benefit of, U.S. Provisional Application No. 63/676,984, which was filed on Jul. 30, 2024, and U.S. Provisional Application No. 63/707,978, which was filed on Oct. 16, 2024, and are incorporated herein by reference in their entirety.

### FIELD OF THE INVENTION

The present invention relates generally to the field of grabbing devices. More specifically, the present invention relates to a picking device that allows a user to easily pick up a plurality of items. Accordingly, the present disclosure makes specific reference thereto. Nonetheless, it is to be appreciated that aspects of the present invention are also equally applicable to other like applications, devices, and methods of manufacture.

### BACKGROUND

Picking up small items off the floor can be a tedious and often uncomfortable task, particularly for those who find themselves needing to repeat this motion multiple times a day. This seemingly simple action can place a significant strain on the back, as frequent bending over engages lower back muscles that are often vulnerable to injury. People of all ages may experience discomfort or even chronic back pain from these repeated movements, but for elderly individuals or those with preexisting back issues, the risks are even more pronounced. Frequent bending can exacerbate joint pain, cause muscle strain, or even result in more serious injuries such as slipped discs, creating lasting health impacts from what might initially appear to be a minor inconvenience.

For individuals with disabilities or limited mobility, picking up objects from the floor can be not only challenging but practically impossible without external assistance. The inability to retrieve necessary items, like a fallen remote control, cell phone, or medication, can lead to feelings of frustration and a loss of independence. Without an easy method to pick up these items, they may have to wait for someone else to assist them, which can be inconvenient and may prevent them from addressing immediate needs, especially if the object is essential. This limitation extends beyond just physical inconvenience; it can impact one's sense of autonomy and self-sufficiency.

Furthermore, even for people without physical limitations, the act of bending down multiple times throughout the day can disrupt productivity, especially if they need to keep a tidy workspace or home environment. Whether in a home, office, or healthcare setting, the task of picking up small items repeatedly can become a considerable nuisance, distracting from more important responsibilities. Ultimately, this simple, repetitive motion has broader implications that affect not only physical well-being but also mental health and quality of life for individuals in a variety of circumstances.

Therefore, there exists a long-felt need in the art for a device that aids a user in picking up items from a ground surface. There also exists a long-felt need in the art for a picking device that aids a user in picking up items from a ground surface in a manner that does not require the user to bend down. Further, there exists a long-felt need in the art for a picking device that aids a user in picking up items from a ground surface in a manner that does not require the user to bend down, and wherein the device can be adapted to pick up a plurality of different item types.

The subject matter disclosed and claimed herein, in one embodiment thereof, comprises a picking device. The device is comprised of a configurable body that may be cylindrical or shaped to fit various design and ergonomic requirements, made from materials like wood, plastic, or metal. The body may include a hinge for folding, facilitated by a locking button or similar control, or may be telescopic, allowing extension or retraction to specified lengths secured by a locking member, preventing unintended adjustments. One end of the device features a handle, ergonomically designed and equipped with a grip area, hanging opening, and an optional adjustable wrist loop for enhanced usability and security. The opposite end includes a head, which may be fixed or articulated through a pivot point, allowing for versatile interaction angles. The head incorporates a fastener, such as an adhesive, magnetic, or hook element, to engage with objects, and may offer replaceable fasteners for task-specific applications, thereby enhancing the device's adaptability.

In this manner, the picking device of the present invention accomplishes all the forgoing objectives and provides a device that aids a user in picking up items from a ground surface. More specifically, the device aids a user in picking up items from a ground surface in a manner that does not require the user to bend down. Further, the device can be adapted to pick up a plurality of different item types.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a picking device comprised of a body with a preferred cylindrical shape but adaptable to other geometric forms, including rectangular, elliptical, or polygonal, to meet design and ergonomic requirements. Constructed from materials like wood, plastic, metal, or composites, the body may include a hinge for foldability, allowing compact storage or easy transport. This hinge operates through a button or alternative control mechanism to secure the folded position when necessary.

In one embodiment, the body is of fixed length, while in another, it is telescopic, allowing for adjustable extension or retraction to various lengths. A locking member, such as a twist-lock or friction clamp, secures the telescopic adjustment, ensuring stability during operation.

At one end of the body, the device includes a handle, which can be ergonomically shaped in configurations like a T-shape or pistol-grip. The handle features a textured grip area for slip prevention and may have an opening for hanging or an adjustable loop, made from materials like fabric or leather, for wrist attachment.

The opposite end of the body includes a head designed to interact with external objects. In some configurations, the head is fixed, providing a stable operating surface. In others, the head attaches via a pivot, allowing multi-directional articulation and lockable positioning through a button or latch mechanism.

The head is further equipped with a fastener for engaging surfaces, such as a floor. Fastener options include adhesive, hook, gel-adhesive, magnetic, or interchangeable designs, enhancing the device's adaptability for varied tasks.

Accordingly, the picking device of the present invention is particularly advantageous as it provides a device that aids a user in picking up items from a ground surface. More specifically, the device aids a user in picking up items from a ground surface in a manner that does not require the user to bend down. Further, the device can be adapted to pick up a plurality of different item types. In this manner, the picking device provides a solution to aiding users in picking up items and objects from a ground surface.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a picking device of the present invention in accordance with the disclosed architecture; and

FIG. 2 illustrates a perspective view of one potential embodiment of a picking device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that aids a user in picking up items from a ground surface. There also exists a long-felt need in the art for a picking device that aids a user in picking up items from a ground surface in a manner that does not require the user to bend down. Further, there exists a long-felt need in the art for a picking device that aids a user in picking up items from a ground surface in a manner that does not require the user to bend down, and wherein the device can be adapted to pick up a plurality of different item types.

The present invention, in one exemplary embodiment, is comprised of a picking device. The device is comprised of a body with a preferred cylindrical shape but is adaptable to other geometric forms, such as rectangular, elliptical, or polygonal, to suit design and ergonomic needs. Made from materials like wood, plastic, metal, or composites, the body may include a hinge for foldability, allowing for compact storage or easy transport. The hinge functions through a button or alternative control to lock the folded position securely.

In one configuration, the body is of fixed length, while in another, it is telescopic, allowing adjustable extension or retraction. A locking member, such as a twist-lock or friction clamp, secures the telescopic adjustment for stability.

One end of the body comprises a handle that can be ergonomically shaped in forms like a T-shape or pistol-grip. The handle features a textured grip area for slip prevention and may have an opening for hanging or an adjustable loop, made from materials such as fabric or leather, for wrist attachment.

The opposite end includes a head for interacting with external objects. In some configurations, the head is fixed, while in others, it attaches via a pivot for multi-directional articulation, with a locking feature like a button or latch.

Additionally, the head includes a fastener for engaging surfaces, such as a floor. Fastener options include adhesive, hook, gel-adhesive, magnetic, or interchangeable designs, enhancing adaptability for various tasks.

Thus, the picking device effectively aids users in retrieving items from ground surfaces without bending down, offering adaptability for different item types and providing an efficient solution for picking up objects.

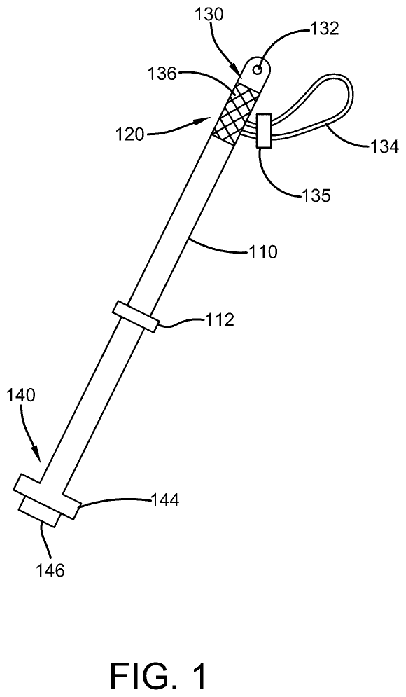

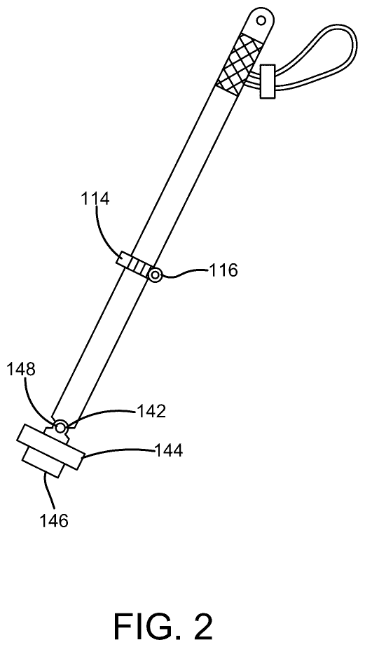

Referring initially to the drawings, FIG. 1 illustrates a perspective view of one potential embodiment of a picking device 100 of the present invention in accordance with the disclosed architecture. The device 100 is comprised of a body 110 that is preferably cylindrical but may also be configured in various geometric shapes, including but not limited to rectangular, elliptical, or polygonal forms, to suit different design preferences and ergonomic requirements. The body 110 is comprised of materials such as wood, plastic, metal, composite materials, or any combination thereof. In one embodiment, the body 110 includes at least one hinge 114 (as seen in FIG. 2) that allows the body 110 to fold, facilitating compact storage or easier transport. The hinge 114 is operable in a locking and unlocking manner through at least one button 116 or an alternative control mechanism such as a latch, switch, or slider, enabling secure folding when needed.

In one embodiment, the body 110 is of a fixed length. In an alternative embodiment, the body 110 is telescopic, allowing the body 110 to extend or retract to a specified length as needed. This telescopic embodiment enables the body 110 to be adjusted to various lengths and subsequently locked in position through at least one locking member 112, which may include a twist-lock, detent pin, friction clamp, or a similar locking mechanism. The locking member 112 is designed to prevent unintentional retraction or extension, ensuring stability during use.

A first end 120 of the body 110 comprises at least one handle 130. The handle 130 may be ergonomically shaped in various configurations, including T-shape, pistol-grip, or cylindrical, to improve comfort and usability. The handle 130 includes a grip area 136, which may feature raised or recessed textures, knurling, or rubberized material to enhance grip and prevent slippage. Additionally, the handle 130 may include at least one opening 132, which allows the device 100 to be conveniently hung on a hook or peg for storage. The device 100 may further be equipped with a fixed or adjustable loop 134, which enables the device to be worn around the user's wrist, providing additional security and ease of access during use. This loop 134 may be constructed from materials such as fabric, leather, or synthetic fibers and may include an adjustment mechanism 135, such as a buckle or sliding adjuster.

The second end 140 of the body 110 is comprised of at least one head 144, which may serve as an interface for interacting with external objects. In one embodiment, the head 144 is in a fixed position relative to the body 110, providing a stable platform for operation. In an alternative embodiment, the head 144 attaches to the second end 140 via at least one pivot point 142, such as a hinge, ball-and-socket joint, or similar mechanism, allowing the head 144 to articulate in multiple directions. This articulation provides versatility in operation, enabling the head 144 to approach objects from various angles. The head 144 may then be locked into a specific position using at least one locking member 148 (as seen in FIG. 2) associated with the pivot point 142, such as a button, latch, or screw mechanism, to prevent undesired movement during use.

The head 144 is further comprised of at least one fastener 146, which enables the device 100 to pick up or interact with objects on surfaces like a floor surface. The fastener 146 may take various forms, including but not limited to an adhesive fastener, a hook, a gel-adhesive fastener, a magnetic fastener, or some combination thereof. In some configurations, the fastener 146 may be replaceable or interchangeable, allowing the user to swap different fasteners for specific tasks, enhancing the versatility and adaptability of the device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “picking device” and “device” are interchangeable and refer to the picking device 100 of the present invention.

Notwithstanding the forgoing, the picking device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the picking device 100 as shown in the FIGS. are for illustrative purposes only, and that many other sizes and shapes of the picking device 100 are well within the scope of the present disclosure. Although the dimensions of the picking device 100 are important design parameters for user convenience, the picking device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A picking device comprising:
a body comprised of a hinge;
a handle disposed at a first end of the body;
a head disposed at a second end of the body; and
wherein the hinge is operable in a locking and unlocking manner through a control mechanism to secure the body in a folded or an unfolded position.

2. The picking device of claim 1, wherein the body is comprised of a cylindrical shape.

3. The picking device of claim 1, wherein the body is comprised of a wood, a plastic, or a metal.

4. The picking device of claim 1, wherein the control mechanism is comprised of a button, a latch, a switch, or a slider.

5. The picking device of claim 1, wherein the handle is comprised of a loop.

6. The picking device of claim 5, wherein the loop is comprised of an adjustment mechanism.

7. The picking device of claim 6, wherein the adjustment mechanism is comprised of a buckle and a sliding adjuster.

8. The picking device of claim 1, wherein the head is comprised of a fastener.

9. A picking device comprising:
a telescopic body;
a locking member adapted to fix the telescopic body at a specified length, wherein the locking member prevents unintentional retraction or extension of the telescopic body during use;
a handle disposed at a first end of the body; and
a head disposed at a second end of the body, the head comprised of a fastener.

10. The picking device of claim 9, wherein the fastener is comprised of an adhesive fastener, a hook, a gel-adhesive fastener, or a magnetic fastener.

11. The picking device of claim 9, wherein the locking member is comprised of a twist-lock, a detent pin, or a friction clamp.

12. The picking device of claim 9, wherein the handle is comprised of an opening.

13. The picking device of claim 9, wherein the handle is comprised of a T-shape, a pistol-grip, or a cylindrical shape.

14. The picking device of claim 9, wherein the handle is comprised of a grip area.

15. A picking device comprising:
a body comprised of a first end and a second end;
a handle disposed on the first end, the handle comprised of a grip area comprised of a texture;
a head disposed at the second end, wherein the head attaches to the second end via a pivot point; and
a fastener positioned on the head.

16. The picking device of claim 15, wherein the fastener is comprised of an adhesive fastener, a hook, a gel-adhesive fastener, or a magnetic fastener.

17. The picking device of claim 15, wherein the pivot point is comprised of a hinge or a ball and socket joint.

18. The picking device of claim 15, wherein the pivot point is comprised of a locking member.

19. The picking device of claim 18, wherein the locking member is comprised of a button, a latch, or a screw.

20. The picking device of claim 15 further comprised of a loop.
